(19) United States
(12) Patent Application Publication
(10) Pub. No.: US 2004/0014882 A1
(43) Pub. Date: Jan. 22, 2004

(54) Aqueous binders

(76) Inventors: Roland Feola, Graz (AT); Ulrike Kuttler, Vasoldsberg (AT); Johann Gmoser, Graz (AT)

Correspondence Address: ProPat, L.L.C., 2912 Crosby Road, Charlotte, NC, 28211-2815, US

(21) Appl. No.: 10/618,788

(22) Filed: Jul. 14, 2003

(30) Foreign Application Priority Data
Jul. 19, 2002 (AT) A 1100/2002

(51) Int. Cl. C08K 3/00

(52) U.S. Cl. 524/589

(57) ABSTRACT

Aqueous binders comprising condensation products AB of carboxyl-containing resins A and hydroxyl group-containing resins B, hydroxyurethanes C, and curing agents D which are active even at temperatures starting at 120° C. wherein the hydroxyurethanes C include units derived from polyfunctional hydroxy compounds Ca having at least 4 carbon atoms, it being possible for some of the carbon atoms to be replaced by oxygen atoms or by ester groups, and at least two hydroxyl groups, and units derived from polyfunctional isocyanates Cb selected from isocyanates of the formula R(NCO)ₙ, where R is an n-functional cycloaliphatic, aliphatic-polycyclic, aromatic-aliphatic-branched or aromatic radical and n is at least 2, and their use for preparing automotive surfacer materials

### FIELD OF THE INVENTION

The invention relates to aqueous binders. It further relates to a method of use of such binders in formulating baking enamels which even at comparatively low baking temperatures produce surfacers for automotive finishing which yield coatings with good stonechip resistance.

### BACKGROUND OF THE INVENTION

There is already patent literature describing binders for automotive surfacer materials which are distinguished by high stonechip resistance:

Thus, in DE-A 4142816 (corresponding to U.S. Pat. No. 5,521,247) there is described an aqueous coating material comprising a reaction product of an acid-functional urethane resin and a hydroxyl-containing polyester resin in a mixture with a non-water-dilutable blocked polyisocyanate and an amine resin as a further crosslinker.

AT-B 408 657 (corresponding to U.S. Pat. No. 6,521,700) relates to a condensation product of a carboxyl-containing resin and a hydroxyl-containing resin in combination with a curing agent composed of a mixture of a water-insoluble blocked isocyanate and a hydrophilically modified isocyanate.

In AT-B 408 658 (corresponding to U.S. Pat. No. 6,406,753), a combination of the abovementioned condensation product is described with a curing agent comprising a water-insoluble nonblocked isocyanate and a hydrophilic, partly etherified amino resin.

In AT-B 408 659 (corresponding to U.S. Pat. No. 6,423,771), the addition of a water-insoluble, low molar mass polyester, rich in hydroxyl groups, to the abovementioned condensation products is disclosed.

EP-A 1 199 342 (corresponding to US 2002/0077389), finally, relates to particular, water-dilutable hydroxyurethanes as admixture resins, producing a distinct increase in the mass fraction of solids both of the binder supply form and of the coating material. In that case it was found, surprisingly, that such admixture resins also improve the stonechip resistance.

All of the abovementioned systems, however, are in need of further improvement. For instance, the ever-increasing requirements of the automotive industry are not always met with the stated systems. One particular recent requirement which has been added is the lowering of the baking temperature from its present level of about 160 to 170° C. to around 140° C., with an underbake safety level down to about 130° C., with no change in the high quality of the cured coatings.

### SUMMARY OF THE INVENTION

It has now been found that, through addition of hydroxyurethanes C which can be prepared by reacting flexible, “soft” polyfunctional hydroxy compounds Ca with rigid, “hard” polyfunctional isocyanates Cb to condensation products AB of hydroxyl-containing resins B and acid-functional resins A and through combinations of these mixtures with curing agents D which are effective even at such low baking temperatures (130 to 140° C.) it is possible to obtain binders which on baking even in the temperature range from 130 to 140° C. lead to coatings which in addition to good all-round properties have excellent stonechip resistance.

The invention accordingly provides aqueous binders comprising condensation products AB of acid-functional resins A and hydroxyl-containing resins B, hydroxyurethanes C, and curing agents D which are active even at temperatures starting at 120° C. wherein the hydroxyurethanes C include units derived from polyfunctional hydroxy compounds Ca having at least 4 carbon atoms, it being possible for some of the carbon atoms to be replaced by oxygen atoms (in the form of ether bonds) or by ester groups, and at least two hydroxyl groups, which are preferably terminal, based on the longest chain of the molecule, and units derived from polyfunctional isocyanates Cb selected from isocyanates of the formula R(NCO)ₙ, where R is an n-functional cycloaliphatic, aliphatic-polycyclic, aromatic-aliphatic-branched or aromatic radical and n is at least 2.

### DETAILED DESCRIPTION OF THE PREFERRED EMBODIMENTS

By flexible or “soft” are meant hydroxy compounds Ca which contain an aliphatic chain having at least 4, preferably at least 5, and in particular at least 6 carbon atoms, it being possible where appropriate for some of the carbon atoms to be replaced by oxygen atoms or ester groups, with any branches present being excluded from the calculation. Preference is given to dihydroxy compounds. This definition covers, for example, 1,4-butanediol, 1,6-hexanediol, and higher homologs, diethylene glycol, triethylene glycol, and higher oligomers, dipropylene glycol, tripropylene glycol, and higher oligomers, and polycaprolactonediols as available, for example, from Interorgana in the ®Placcel L series. Mixtures of these hydroxy compounds can also be used. By rigid or “hard” are meant polyfunctional isocyanates Cb of the formula R(NCO)ₙ, wherein the radical R is a cycloaliphatic, aliphatic-polycyclic, aromatic-aliphatic-branched or aromatic radical, in the latter case the isocyanate groups preferably being attached to different aromatic nuclei. Preference is given to diisocyanates (n=2). This group includes, for example, isophorone diisocyanate, norbornane diisocyanate, dicyclohexylmethane diisocyanate, tetramethylxylylene diisocyanate, diphenylmethane diisocyanate, 4,4′-diisocyanatobiphenyl, and naphthalene 1,5-diisocyanate. Mixtures of these isocyanates can also be used.

The hydroxyurethanes C are preferably of strictly linear construction—this is the case when exclusive use is made of diols as component Ca and of diisocyanates as component Cb. In order to achieve a certain degree of branching, which may be advantageous where appropriate, it is possible as well to use fractions (in each case up to 10% of the difunctional reactants) of polyols, preferably triols, Ca′ as part of component Ca and/or isocyanates Cb′ having more than two isocyanate groups per molecule as part of component Cb. These substances of higher functionality are then no longer required to satisfy the aforementioned “hard/soft” definition. From the plethora of suitable polyols Ca′ mention may be made, for example, of trimethylolpropane, trimethylolethane, ditrimethylolpropane, erythritol, pentaerythritol, sorbitol, and polycaprolactonetriols ®Placcel 300 series, Interorgana). Examples of suitable isocyanates Cb′ having a functionality of more than 2 include trimerized hexamethylene diisocyanate ®Desmodur N 3300, Bayer, about 3 NCO groups per molecule) and oligomeric diphenylmethane diisocyanate with about 2.3 NCO groups per molecule ®Desmodur VL, Bayer).

The presence of hydroxyl groups in the hydroxyurethane C is ascertained by making sure that the amount of substance of the hydroxyl groups of component Ca is always greater than that of the isocyanate groups of component Cb in the reactant mixture.

For the synthesis of the hydroxyurethanes C a preferred procedure is to introduce the hydroxy compound Ca or a mixture of hydroxy compounds Ca and to run the polyfunctional isocyanate Cb or a mixture of polyfunctional isocyanates Cb into this initial charge with stirring at from 50 to 130° C. at a rate such that the heat given off remains readily manageable. When addition is complete the reaction mixture is held at elevated temperature until no isocyanate groups, or virtually none, are detectable any longer. For further processing the hydroxyurethanes C thus prepared can be used either in solvent-free form, as a melt, or else in dilution in an appropriate solvent, as admixture resins. Since these admixture resins are of only limited water-solubility, if any, the preparation of water-dilutable binders they must be “borne” by the water-soluble condensate formed from hydroxyl-containing and carboxyl-containing resins (see documents AT-B 408 657 and AT-B 408 658), in other words must be emulsified by these resins in water.

Through an appropriate choice of the stoichiometric proportions of the reactants Ca and Cb and of their functionality, where reactants with a functionality of more than two are used, it is possible to influence the degree of polymerization of the hydroxyurethane. It is preferred to aim for a range which produces a Staudinger index (formerly termed “intrinsic viscosity number”) of at least 4 to a maximum of 25 cm³/g. The choice of the most favorable degree of polymerization in any given case depends on the one hand on compatibility with the particular condensate used and hence on the stability of the binder dispersion, and on the other hand, of course, on the technical coating properties obtained (ease of application, surface quality, etc.). The most favorable degree of polymerization of the hydroxyurethane must be evaluated on a case-by-case basis. The hydroxyurethanes C preferably have a Staudinger index from 4 to 19 cm³/g, measured in dimethylformamide solvent at 23° C.

The ready-made, water-soluble binders contain not only said hydroxyurethanes C but also the abovementioned condensates AB, which are described in detail in U.S. Pat. No. 6,521,700 herein incorporated by reference. These condensation products AB of an acid-functional resin A and a hydroxyl-containing resin B, the resin A preferably having an acid number of from 100 to 230 mg/g, in particular from 120 to 160 mg/g, and a resin B preferably having a hydroxyl number from 50 to 500 mg/g, in particular from 60 to 350 mg/g, preferably have an acid number of from 25 to 75 mg/g, in particular from 30 to 50 mg/g. Their Staudinger index (“intrinsic viscosity number”, measured in dimethylformamide solvent at 23° C.) is normally from 10 to 20 cm³/g, in particular from 12 to 19 cm³/g, and especially preferred from 13 to 18 cm³/g.

The mass fraction of the hydroxy urethanes C in the sum of the masses of the condensation products AB and of the hydroxyurethane C is between 5 and 40% (from 5 to 40 cg/g, the specified masses being in each case those of the solids fractions). The mass fraction of C is preferably from 10 to 35 cg/g, in particular from 15 to 30 cg/g.

In the preparation of the condensation product AB, components A and B are used preferably in a mass ratio of from 10:90 to 80:20, in particular from 15:85 to 40:60. The condensation products AB are prepared from the polyhydroxy components B and the polyacyl components A under condensation conditions, i.e., at a temperature of from 80 to 180° C., preferably between 90 and 170° C., preferably in the presence of solvents which form azeotropes with the water formed during the condensation. The condensation is continued until the condensation products AB have the acid numbers specified above. Following at least partial neutralization of the remaining carboxyl groups (with preferably from 10 to 80% of the carboxyl groups being neutralized, more preferably from 25% to 70%) the condensation products AB are dispersible in water. During the condensation it is possible to observe how the reaction mixture, which is cloudy to begin with, becomes clear and forms a homogeneous phase.

The resins A with acid groups are preferably selected from polyester resins A1, polyurethane resins A2, those known as maleate oils A3, the graft products A4 of fatty acids and mixtures thereof grafted with unsaturated carboxylic acids, acrylic resins A5, and phosphoric or phosphonic-acid-modified epoxy resins A6. The acid number of the resins A is preferably from 100 to 230 mg/g, in particular from 70 to 160 mg/g. Their Staudinger index, measured in dimethylformamide solvent at 23° C., is generally from about 6.5 to 12 cm³/g, preferably from 8 to 11 cm³/g.

Suitable polyester resins A1 can be prepared conventionally from polyols A11 and polycarboxylic acids A12, it being possible for some—preferably up to 25%—of the amount of substance of the polyols and polycarboxylic acids to be replaced by hydroxycarboxylic acids A13. An appropriate choice of the nature and amount of the reactants A11 and A12 ensures that the resultant polyester has a sufficient number of acid groups, corresponding to the acid number indicated above. The polyols A11 are preferably selected from aliphatic and cycloaliphatic alcohols having 2 to 10 carbon atoms and on average at least two hydroxyl groups per molecule: those particularly suitable include glycol, 1,2- and 1,3-propanediol, 1,4-butanediol, 1,6-hexanediol, neopentyl glycol, diethylene and triethylene glycol, dipropylene and tripropylene glycol, glycerol, trimethylolpropane, and trimethylolethane. Suitable polycarboxylic acids A12 are aliphatic, cycloaliphatic, and aromatic polycarboxylic acids such as adipic acid, succinic acid, cyclohexanedicarboxylic acid, phthalic acid, isophthalic and terephthalic acid, trimellitic acid and trimesic acid, and benzophenonetetracarboxylic acid. It is also possible to use compounds which contain both carboxylic and sulfonic acid groups, such as sulfoisophthalic acid, for example.

Suitable polyurethane resins A2 can be prepared by reacting aliphatic polyols A21 as defined under A11, hydroxyalkanecarboxylic acids A22 having at least one, preferably two, hydroxyl groups and a carboxyl group which is less reactive than adipic acid under esterification conditions; preference is given to using dihydroxy monocarboxylic acids selected from dimethylolacetic acid, dimethylolbutyric acid, and dimethylolpropionic acid, oligomeric or polymeric compounds A25 having on average at least two hydroxyl groups per molecule, which can be selected from polyetherpolyols A251, polyesterpolyols A252, polycarbonatepolyols A253, and saturated and unsaturated dihydroxyaliphatic compounds A254, which are obtainable by oligomerizing or polymerizing dienes having 4 to 12 carbon atoms, especially butadiene, isoprene, and dimethylbutadiene, and then functionalizing them, in a known manner, and also polyfunctional isocyanates A23, preferably selected from aromatic, cycloaliphatic, and linear and branched aliphatic difunctional isocyanates such as tolylene diisocyanate, bis(4-isocyanatophenyl)-methane, tetramethylxylylene diisocyanate, isophorone diisocyanate, bis(4-isocyanatocyclohexyl)methane, hexamethylene diisocyanate, and 1,6-diisocyanato-3,3,5- and -3,5,5-trimethylhexane.

Particular preference is given to polyurethane resins A2 preparable by reacting a mixture of one or more polyols A21 with a hydroxyalkanecarboxylic acid A22 and at least one polyfunctional isocyanate A23 blocked at least partially, normally to more than 20%, preferably to more than 35%, and in particular to 50% or more, with mono-hydroxy compounds A24 selected from polyalkylene glycol monoalkyl ethers HO—(R¹—O)ₙ—R², where R¹ is a linear or branched alkylene radical having 2 to 6, preferably 2 to 4, carbon atoms and R² is an alkyl group having 1 to 8, preferably 2 to 6, carbon atoms and from oximes of aliphatic ketones having 3 to 9 carbon atoms and n is an integer of from 1 to 40. The degree of blocking is specified here as the fraction of the blocked isocyanate groups, based on the total (blocked and nonblocked) isocyanate groups present in the isocyanate A23. It is further preferred to prepare the polyurethane resins A2 by reacting a mixture of a polyfunctional isocyanate and of a polyfunctional isocyanate blocked in the manner described above with the hydroxyalkanecarboxylic acid A22 and the polyols A21 and A25, the proportions of the mixture being such that in each molecule of the polyurethane A2 there is on average one or more than one terminal blocked isocyanate group.

“Maleate oils” A3 are reaction products of (drying) oils A31 and olefinically unsaturated carboxylic acids A32, especially dicarboxylic acids. The oils A31 used are preferably drying and semidrying oils such as linseed oil, tall oil, rapeseed oil, sunflower oil, and cotton seed oil, with iodine numbers of from about 100 to about 180. The unsaturated carboxylic acids A32 are selected such that under the customary conditions they undergo grafting free-radically (following the addition of initiators or after heating) to the initial charge of oils with a yield (fraction of unsaturated carboxylic acids joined to the oil after the reaction, based on the amount employed for the reaction) of more than 50%. Among those particularly suitable are maleic acid in the form of its anhydride, and also tetrahydrophthalic anhydride, acrylic and methacrylic acid, and citraconic, mesaconic, and itaconic acid.

Likewise suitable resins A4 are fatty acids or mixtures thereof, A41, which have been grafted with the unsaturated acids specified under A32, the fatty acids or mixtures thereof being obtainable in industrial quantities by hydrolysis of fats. The fatty acids which are suitable have at least one olefinic double bond in their molecule: examples include oleic acid, linoleic and linolenic acid, ricinoleic acid, and elaidic acid, and also the said industrial mixtures of such acids.

Further suitable resins A5 are the acidic acrylic resins which are obtainable by copolymerizing olefinically unsaturated carboxylic acids A51 and other vinyl or acrylic monomers A52. The carboxylic acids are those already specified under A32, plus vinyl acetic acid and also crotonic and isocrotonic acid and the monoesters of olefinically unsaturated dicarboxylic acids such as monomethyl maleate and monomethyl fumarate, for example. Suitable monomers A52 are the alkyl esters of acrylic and methacrylic acid having preferably 1 to 8 carbon atoms in the alkyl group, (meth)acrylonitrile, hydroxylalkyl (meth)acrylates having 2 to 6 carbon atoms in the alkyl group, styrene, vinyltoluene, and vinyl esters of aliphatic linear and branched carboxylic acids having 2 to 15 carbon atoms, especially vinyl acetate and the vinyl ester of a mixture of branched aliphatic carboxylic acids having on average from 9 to 11 carbon atoms. It is also advantageous to copolymerize the monomers specified under A51 and A52 in the presence of compounds A53 which react with the unsaturated carboxylic acids in an addition reaction with the formation of a carboxyl- or hydroxyl-functional copolymerizable compound. Examples of such compounds include lactones A531, which react with the carboxylic acids A51 in a ring-opening reaction to form a carboxyl-functional unsaturated compound, and epoxides A532, especially glycidyl esters of a-branched saturated aliphatic acids having 5 to 12 carbon atoms such as of neodecanoic acid or of neopentanoic acid, which react with the acid A51 in an addition reaction to form a copolymerizable compound having one hydroxyl group. The amounts of substance of the compounds used are to be such that the required acid number is attained. If this compound A53 is used as the initial charge and the polymerization is conducted in such a way that this compound is used as (sole) solvent, then solvent-free acrylic resins are obtained.

The phosphoric- or phosphonic-acid-modified epoxy resins or adducts of epoxy resins and fatty acids, A6, are prepared by reaction—preferably in a solvent—of phosphoric acid or of organic phosphonic acids which are at least dibasic with epoxy resins or with adducts of epoxy resins and fatty acids. The amount of substance of the phosphoric or phosphonic acid used is normally such that all of the epoxide groups are consumed by the reaction of the acid and such that a sufficient number of acid groups is still available after the reaction. The resin formed contains hydroxyl groups (from the reaction of the oxirane group with the acid function) which are in a β position to the ester group; possibly hydroxyl groups in the glycidyl alcohol residues attached in the manner of ethers, from the epoxy resin; and acid groups of the phosphoric or phosphonic acid which were not consumed by the reaction with the epoxide.

Particularly suitable hydroxyl group-containing resins B are polyesters B1, acrylic resins B2, polyurethane resins B3, and epoxy resins B4. The hydroxyl number of the resins B is generally from about 50 to 500 mg/g, preferably from about 60 to 350 mg/g, and with particular preference from 70 to 300 mg/g. Their Staudinger index, measured at 23° C. and dimethylformamide solvent, is preferably from 8 to 13 cm³/g, and in particular from 9.5 to 12 cM³/g.

Like component A1, the polyesters B1 are prepared by polycondensation; all that is necessary here is to choose the nature and amount of the reactants in such a way that there is an excess of hydroxyl groups over the acid groups, it being necessary for the condensation product to have the hydroxyl number specified above. This can be achieved by using polyhydric alcohols having on average at least two, preferably 2.1, hydroxyl groups per molecule with dicarboxylic acids or with a mixture of polycarboxylic and monocarboxylic acids having on average not more than two, preferably from 1.5 to 1.95, acid groups per molecule. Another possibility is to use a corresponding excess of hydroxyl components (polyols) B11 over the acids B12. The polyols B11 and the polyfunctional acids B12 which are reacted in the polycondensation reaction to give the hydroxyl-containing polyesters B1 are selected from the same groups as the polyols A11 and the acids A12. Here as well it is possible to replace some of the polyols and acids by hydroxy acids in accordance with A13. The aim here is for the acid number of component B to be not above 20 mg/g, preferably below 18 mg/g. The acid number can be lowered, for example, by reacting the condensed polyester Bi further with a small amount of monohydric aliphatic alcohols A14 under esterification conditions. In this reaction the amount of alcohols A14 is to be calculated such that, although the acid number is lowered to below the limit, the Staudinger index does not fall below the stated lower limit. Examples of suitable aliphatic alcohols include n-hexanol, 2-ethylhexanol, isodecyl alcohol, and tridecyl alcohol.

The hydroxyl group-containing acrylic resins B2 are obtainable by normally free-radically initiated copolymerization of hydroxyl group-containing acrylic monomers B21 with other vinyl or acrylic monomers B22 without such functionality. Examples of the monomers B21 are esters of acrylic and methacrylic acid with aliphatic polyols, especially diols having 2 to 10 carbon atoms, such as hydroxyethyl and hydroxypropyl (meth)acrylate. Examples of the monomers B22 are the alkyl esters of (meth)acrylic acid having 1 to 10 carbon atoms in the alkyl group such as methyl, ethyl, n-butyl, and 2-ethylhexyl (meth)acrylate, (meth)acrylonitrile, styrene, vinyltoluene, and vinyl esters of aliphatic monocarboxylic acids having 1 to 10 carbon atoms such as vinyl acetate and vinyl propionate. Preference is also given to those acrylic resins not prepared in the usual manner in solution but instead in a bulk polymerization, in which a liquid cyclic compound (see above, A53) is introduced, which acts as a solvent during a polymerization reaction, and which during the reaction with one of the monomers used undergoes ring opening to form a copolymerizable compound. Examples of such compounds are glycidyl esters of a-branched aliphatic monocarboxylic acids, especially the acids or acid mixtures available commercially as neopentanoic acid or neodecanoic acid, and also lactones such as ε-caprolactone or δ-valerolactone. If these glycidyl esters are used it is necessary in the polymerization to employ a fraction of acid-functional comonomers, such as (meth)acrylic acid, which is at least equimolar with the amount of substance of the epoxide groups. With ring opening, the lactones can be used with both hydroxyl group-containing and acid-functional comonomers.

Hydroxyl group-containing polyurethane resins B3 are obtainable conventionally by addition reaction with oligomeric or polymeric polyols B31, selected from polyester polyols, polyether polyols, polycarbonate polyols, and polyolefin polyols, where appropriate, low molar mass aliphatic diols or polyols B33 having 2 to 12 carbon atoms, such as ethylene glycol, 1,2- and 1,3-propylene glycol, 1,4-butanediol, 1,6-hexanediol, di- and tri-ethylene and -propylene glycol, neopentyl glycol, trimethylolpropane, and pentaerythritol, and polyfunctional isocyanates B32, the latter being used with a stoichiometric deficit such that the number of hydroxyl groups in the reaction mixture is greater than that of the isocyanate groups. Suitable polyols are, in particular, oligomeric and polymeric dihydroxy compounds having a number-average molar mass Mn of from about 200 to 10000 g/mol. By polyaddition with polyfunctional isocyanates, especially difunctional isocyanates, they are built up to the target value for the Staudinger index of at least 8 cm³/g, preferably at least 9.5 cm³/g. Epoxy resins B4, which are obtainable by reacting a chlorohydrine with aliphatic or aromatic diols or polyols, especially bisphenol A, bisphenol F, recorcinol, novolaks or oligomeric polyoxyalkylene glycols having 2 to 4, preferably 3, carbon atoms in the alkylene group, contain one epoxide group per molecule of epichlorohydrin used. Instead of the reaction of epichlorohydrin with diols, the appropriate epoxy resins can also be prepared by the so-called advancement reaction from diglycidyl ethers of diols (such as those mentioned above) or diglycidyl esters of dibasic organic acids with said diols. All known epoxy resins can be used here, provided they satisfy the condition relating to the hydroxyl number.

For crosslinking, the binder mixtures comprising the condensate AB and the admixture resin C are combined preferably with water-dilutable amino resins D1, especially melamine resins. It is, however, also possible where appropriate to use suitable blocked polyisocyanates D2 as a curing component as well, in which case its proportion based on the mass of the curing agents used overall (in each case the fraction of the solids) can be preferably up to 30% and with particular preference up to 15%. Admixing the hydroxyurethanes C considerably improves the stonechip resistance of the water-soluble binders thus modified, and the coatings produced therewith can be cured even at temperatures of from 130 to 140° C. Surprisingly, the gloss as well is markedly improved.

The amino resin D1 is preferably used in partly or fully etherified form. Particularly suitable are melamine resins such as hexamethoxymethylmelamine, products eterified with butanol or with mixtures of butanol and methanol, and also the corresponding benzoguanamine, caprinoguanamine or acetoguanamine resins. Melamine resins are preferred, and may be partly or fully etherified, with methanol being the preferred etherifying alcohol.

Suitable blocked isocyanates D2 are obtainable by reacting polyfunctional aromatic, aliphatic or mixed aromatic-aliphatic isocyanates with monofunctional compounds which are reactive towards isocyanate and are referred to as blocking agents. The products of this reaction are cleaved back into their reactants, isocyanate and blocking agent, at elevated temperature, i.e., at above 100° C., preferably at above just 100° C., and in certain cases even from 80° C. upward. In the curing process the blocking agent is released and is able to escape from the coating film, which as yet is incompletely cured. Preference is given to blocked isocyanates which are obtainable conventionally from diisocyanates such as tolylene diisocyanate, isophorone diisocyanate, bis(4-isocyanatophenyl)methane, 1,6-diisocyanatohexane, tetramethylxylylene diisocyanate, and the allophanates, biurets, uretdiones formed from these diisocyanates, and customary blocking agents. Examples of such customary blocking agents are linear or branched aliphatic alcohols having 3 to 20 carbon atoms, preferably 2-ethylhexanol; phenols such as phenol itself; glycol monoesters, where the glycols can be monomeric or oligomeric alkylene glycols such as glycol itself, 1,2- and 1,3-propanediol, 1,4-butanediol, diethylene and triethylene glycol or dipropylene and tripropylene glycol, and the acid is selected from aliphatic monocarboxylic acids having 1 to 10 carbon atoms, preferably acetic acid; glycol monoethers, where the glycols are those mentioned above and the etherifying component is selected from lower aliphatic alcohols having 1 to 8 carbon atoms, preferably butyl glycol; or ketoximes of aliphatic ketones having 3 to 10 carbon atoms, such as butanone oxime, for example. It is particularly preferred to use 3,5-dimethylpyrazole as a blocking agent, since it is not toxic and does not yellow even at temperatures of 180° C. or more. The blocking agents are normally chosen so that the unblocking temperature is between 80 and 180° C. Particular preference is given to blocked isocyanates based on isophorone diisocyanate and 1,6-diisocyanatohexane.

It is also possible to use hydrophilic blocked isocyanates. In this context, refer to the relevant disclosure content of Austrian patent AT-B 408 657, which is incorporated herein by reference.

The invention further provides aqueous coating materials which comprise the condensation products AB, the hydroxy-urethanes C and curing agents D, and also pigments and fillers plus, if desired, further additives such as wetting agents, antisettling agents, flow improvers, thickeners, and leveling agents.

With the aqueous binders of the invention it is possible to formulate aqueous coating materials which lead to coatings having high gloss and good resistance to stonechipping. Such coating materials are employed in particular for automotive surfacers. The coating materials are preferably prepared by mixing components AB and C, dividing this mixture, the first portion being intimately mixed with pigments and fillers and other additives to form a paste and subsequently formulating this paste to the finished coating material by adding the remainder of the mixture of AB and C, the curing agent D, and, where appropriate, further additives and water.

The examples below illustrate the invention.

### EXAMPLES

In the examples below, as in the foregoing text, all figures with the unit “%” denote mass fractions (ratio of the mass of the substance in question to the mass of the mixture), unless specified otherwise. Concentration figures in “%” are mass fractions of the dissolved substance in the solution (mass of the dissolved substance divided by the mass of the solution). In the examples the following abbreviations have been used (M: molar mass):

| EP380 | diepoxy resin having a specific epoxide group | |
|---|---|---|
| | content of about 5.26 mol/kg (“epoxide | |
| | equivalent weight” EEW about 190 g/mol) | |
| DGM | diethylene glycol dimethyl ether | |
| MIBK | methyl isobutyl ketone | |
| TDI | tolylene diisocyanate | M = 174 g/mol |
| HD | 1,6-hexanediol | M = 118 g/mol |
| BD | 1,4-butanediol | M = 90 g/mol |
| CD | polycaprolactonediol* | M = 550 g/mol |
| DEG | diethylene glycol | M = 106 g/mol |
| TPG | tripropylene glycol | M = 192 g/mol |
| DPG | dipropylene glycol | M = 134 g/mol |
| TMP | trimethylolpropane | M = 134 g/mol |
| IPDI | isophorone diisocyanate | M = 222 g/mol |
| DCHDI | dicyclohexylmethane | M = 262 g/mol |
| | diisocyanate | |
| TMXDI | tetramethylxylylene | M = 244 g/mol |
| | diisocyanate | |
| THDI | trimerized hexamethylene | M = 575 g/mol |
| | diisocyanate+ | |

* ® Placcel 205, Interorgana
+Desmodur N 3300, Bayer

Preparation of Admixture Component C:

C1: A three-necked flask equipped with stirrer and reflux condenser was charged with 236 g (2.0 mol) of 1,6-hexanediol and 90 g (1.0 mol) of 1,4-butanediol and the mixture was heated to 80° C. Subsequently 444 g (2.0 mol) of isophorone diisocyanate were added over the course of two hours with stirring.

With occasional cooling the temperature was allowed to rise to 90° C. When addition was complete the reaction mixture was held at 90° C. until free isocyanate was no longer detectable (about 2 h) Finally, the product was diluted with methoxypropanol to a mass fraction of solids of about 80% (NVC, nonvolatiles content). This gave a product having a Staudinger index (“intrinsic viscosity number”, measured in dimethylformamide at 23° C.) of 5.5 cm³/g.

In analogy to the procedure described above, further dihydroxyurethanes were prepared (see Table 1).

TABLE 1
Preparation of dihydroxyurethanes

| | | | Staudinger | Yield resin | Hydroxyl |
|---|---|---|---|---|---|
| Admixture | Dihydroxy compound | Diisocyanate | index | solids | number |
| resin | type\|n_{H} in mol\|m_{H} in g | type\|n_{I} in mol\|m_{I} in g | J₀ in cm³/g | mₛ in g | in mg/g |
| C1 | HD\|2.0\|236 | IPDI\|2.0\|444 | 5.5 | 770 | 145 |
| | BD\|1.0\|90 | | | | |
| C2 | BD\|2.0\|180 | DCHDI\|2.2\|576 | 8.9 | 1306 | 69 |
| | CD\|1.0\|550 | | | | |
| C3 | DEG\|2.0\|212 | DCHDI\|1.5\|393 | 4.8 | 880 | 127 |
| | CD\|0.5\|275 | | | | |
| C4 | HD\|2.2\|260 | IPDI\|2.0\|444 | 6.7 | 858 | 130 |
| | TPG\|0.8\|154 | | | | |
| C5 | BD\|2.0\|180 | TMXDI\|2.1\|512 | 6.8 | 1242 | 81 |
| | CD\|1.0\|550 | | | | |
| C6 | BD\|3.3\|297 | IPDI\|3.0\|666 | 7.8 | 1348 | 83 |
| | CD\|0.7\|385 | | | | |
| C7 | HD\|2.0\|236 | IPDI\|1.0\|222 | 6.4 | 836 | 134 |
| | DPG\|1.0\|134 | TMXDI\|1.0\|244 | | | |
| C8 | TMP\|2.0\|268 | IPDI\|2.0\|444 | 7 | 1032 | 108 |
| | CD\|0.5\|275 | | | | |
| | BD\|0.5\|45 | | | | |
| C9 | HD\|2.0\|236 | IPDI\|2.0\|444 | 8 | 827 | 122 |
| | BD\|1.0\|90 | THDI\|0.1\|57 | | | |

n_{H}; m_{H}: Amount of substance and mass of hydroxy compound Ca
n_{I}; m_{I}: Amount of substance and mass of isocyanate compound Cb
mₛ: Mass of resin solids of hydroxyurethane C

Polyester PE (Comparative Example)

A three-necked flask equipped with stirrer and reflux condenser was charged with 150 g (1.0 mol) of triethylene glycol and this initial charge was heated to 120° C. under inert gas. Then 148 g (1.0 mol) phthalic anhydride were added and the temperature was raised to 150° C., utilizing the heat given off. When an acid number of 180 mg/g had been reached 134 g (1.0 mol) of trimethylolpropane were added, the batch was slowly heated to 220° C., a distillation circuit was set up with xylene, and, with removal of the water of reaction produced, esterification was carried out until an acid number of less than 5 mg/g was reached. Finally the azeotrope former was stripped off by distillation under reduced pressure.

Preparation of the Polycarboxyl Components A

Carboxyl-Containing Polyurethane (A 1)

A suitable reaction vessel was charged with a solution of 810 g (6 mol) of dimethylolpropionic acid in 946 g of DGM and 526 g of MIBK. Over the course of 4 hours a mixture of 870 g (5 mol) of TDI and 528 g (2 mol) of TDI semiblocked with ethylene glycol monoethyl ether simultaneously was added to this solution at 100° C. As soon as all the NCO groups had reacted the batch was diluted with a mixture of DGM and MIBK (mass ratio 2:1) to a mass fraction of solids of 60%. The component (Al) had an acid number of 140 mg/g and a Staudinger index (“intrinsic viscosity number”), measured in N,N-dimethylformamide (DMF) at 23° C., of 9.3 cm³/g.

The semiblocked TDI was prepared by adding 90 g (1 mol) of ethylene glycol monoethyl ether to 174 g (1 mol) of TDI over the course of 2 hours at 30° C. and then reacting the mixture until it had a mass fraction of unreacted isocyanate groups (“NCO value”) of 16 to 17%.

Acid-Modified Epoxy Resin (A 2)

An appropriate reaction vessel was charged with a mixture of 146 g (1.0 mol) of adipic acid, 40 g (0.3 mol) of phosphoric acid (75% strength solution in water) and 46 g of methoxypropanol. The mixture was heated to 70° C. and over the course of 1 hour 323 g (amount of substance of epoxide groups 1.7 mol) of EP 380 were added with stirring. As a result of the slight exotherm the temperature rose to about 80° C. When addition was complete the batch was heated to 110° C. and held at this temperature until an acid number of 130 to 140 mg/g was reached.

Carboxyl-Containing Polyester (A 3)

A three-necked flask equipped with stirrer and reflux condenser was charged with 140 g (1.3 mol) of diethylene glycol and 152 g (1.1 mol) of trimethylolpropane. With stirring and under inert gas the mixture was heated to 100° C. and at this temperature, in portions, 109 g (0.6 mol) of isophthalic acid, 96 g (0.6 mol) of adipic acid and lastly 198 g (1.3 mol) of phthalic anhydride were added. The temperature was raised to 130° C., utilizing the heat evolved during the reaction.

After the batch had been held at 130° C. for two hours it was slowly heated to 180° C. and esterified, with removal of the water of reaction which was now produced, to an acid number of 50 mg/g.

When the stated acid number had been reached the product was diluted with butyl glycol to a mass fraction of solids of 60% and finally was neutralized by adding 14 g (0.16 mol) of N,N-dimethylethanolamine.

The product thus obtained was infinitely water-dilutable.

Preparation of Polyhydroxyl Components B

Polyester (B 1):

In a suitable reaction vessel 130 g (1.1 mol) of hexane-1,6-diol, 82 g (0.6 mol) of pentaerythritol, 8 g (0.05 mol) of isononanoic acid, 28 g (0.1 mol) of ricinene fatty acid (dehydrated castor oil fatty acid) and 50 g (0.3 mol) of isophthalic acid were esterified at 210° C. to an acid number of less than 4 mg/g. The viscosity of a 50% strength solution in ethylene glycol monobutyl ether, measured as the efflux time in accordance with DIN 53211 at 20° C., was 125 seconds and the Staudinger index, measured in N,N-dimethylformamide at 23° C., was 9.8 cm³/g.

Polyester (B 2):

In the same way as for polyester B 1, 38 g (0.2 mol) of tripropylene glycol, 125 g (1.2 mol) of neopentyl glycol, 28 g (0.1 mol) of isomerized linoleic acid, 83 g (0.5 mol) of isophthalic acid and 58 g (0.3 mol) of trimellitic anhydride were esterified at 230° C. to an acid number of less than 4 mg/g. The viscosity of a 50% strength solution in ethylene glycol monobutyl ether, measured as the efflux time in accordance with DIN 53211 at 20° C., was 165 seconds. The Staudinger index, measured in N,N-dimethylformamide at 23° C., was 10.5 cm³/g.

Preparation of Binder Components (Condensation Products AB)

In accordance with the mass ratios indicated in Table 2 the polycarboxyl components (A) and the polyhydroxyl components (B) were mixed and the solvent present was largely removed under reduced pressure while heating to a reaction temperature of 160° C. This temperature was maintained until the desired acid number had been reached, at which point a sample was perfectly dilutable with water following neutralization with dimethylethanolamine. 80 g of the condensate (solids) obtained in this way were mixed at 90° C. with in each case 20 g (solids) of the stated dihydroxyurethane C, neutralized with the corresponding amount of dimethylethanolamine to a degree of neutralization of 80% (based on the acid groups present in each case), and, after a homogenizing′ time of 30 minutes, diluted with water in portions to a viscosity of below 3000 mPa·s at 23° C.

In the case of the comparative examples the compound mixed in was, instead of the dihydroxyurethane, 20 g (solids) of a low molar mass, hydroxyl group-containing polyester (PE).

In the case of the control sample the condensate formed from the polycarboxyl component (A) and the polyhydroxyl component (B) was neutralized as indicated above, without further modification, and diluted with water.

TABLE 2

| | | | | | Acid number | | | | Mass |
|---|---|---|---|---|---|---|---|---|---|
| | | | | | of | Admixture | | | fraction |
| | Component A | | Component B | | condensate | component C | | Viscosity | of |
| | Mass | | Mass | | AB | Mass | | (23° C.) | solids |
| Example | in g | type | in g | type | mg/g | in g | type | η in mPa · s | in % |
| 1 | 30 | A1 | 50 | B1 | 45 | 20 | C1 | 2607 | 46 |
| 2 | 30 | A2 | 50 | B2 | 43 | 20 | C2 | 2433 | 39.4 |
| 3 | 30 | A1 | 50 | B1 | 43 | 20 | C3 | 2130 | 41 |
| 4 | 30 | A1 | 50 | B1 | 42 | 20 | C4 | 2233 | 38.8 |
| 5 | 30 | A2 | 50 | B2 | 42 | 20 | C5 | 1980 | 44.2 |
| 6 | 30 | A2 | 50 | B2 | 44 | 20 | C6 | 2330 | 42 |
| 7 | 30 | A1 | 50 | B1 | 43 | 20 | C7 | 1844 | 41.2 |
| 8 | 30 | A2 | 50 | B2 | 47 | 20 | C8 | 2720 | 38.6 |
| 9 | 30 | A3 | | | 50 | 20 | C9 | 1977 | 37.8 |
| 10 | 30 | A3 | | | 50 | 20 | C1 | 1739 | 40.9 |

Comparative examples

| | | | | | | | | | |
|---|---|---|---|---|---|---|---|---|---|
| 11 | 30 | A1 | 50 | B1 | 43 | 20 | PE | 2226 | 37 |
| 12 | 30 | A2 | 50 | B2 | 42 | 20 | PE | 1989 | 37.8 |
| 13 | 30 | A3 | | | 50 | 20 | PE | 2243 | 36.2 |

Performance Testing:

Testing of the binders of the invention as automotive surfacers

Using the formulations indicated in Table 3, aqueous surfacer materials were prepared by a customary procedure and were each adjusted to a viscosity of 120 mPa·s (1.2 poise) by further addition of deionized water (designated in the table by “deionized water 2”). Coating paints 1 to 5 were applied to cleaned glass plates using a 150 μm doctor blade and after a 15-minute flash-off period were baked at 140° C. for 20 minutes. The coatings obtained were used for determination of the pendulum hardness and the gloss, and were also subjected to visual assessment.

TABLE 3
Surfacer examples

| | | Paint | Paint | Paint | | |
|---|---|---|---|---|---|---|
| | | 1 | 2 | 3 | Paint 4 | Paint 5 |
| Binder 1 | in g | 91.8 | — | — | — | — |
| Binder 3 | in g | — | 103.0 | — | — | — |
| Binder 8 | in g | — | — | 109.2 | — | — |
| Binder 11 | in g | — | — | — | 114.0 | — |
| (comparative) | | | | | | |
| Binder 12 | in g | — | — | — | — | 111.6 |
| (comparative) | | | | | | |
| Wetting agent* | in g | 1.2 | 1.2 | 1.2 | 1.2 | 1.2 |
| Deionized water 1 | in g | 15.0 | 18.0 | 25.0 | 28.0 | 25.0 |
| Titanium dioxide | in g | 60.0 | 60.0 | 60.0 | 60.0 | 60.0 |
| Filler | in g | 60.0 | 60.0 | 60.0 | 60.0 | 60.0 |
| Binder 1 | in g | 130.0 | — | — | — | — |
| Binder 3 | in g | — | 145.8 | — | — | — |
| Binder 8 | in g | — | — | 155.2 | — | — |
| Binder 11 | in g | — | — | — | 161.6 | — |
| (comparative) | | | | | | |
| Binder 12 | in g | — | — | — | — | 158.2 |
| (comparative) | | | | | | |
| Amino resin‡ | in g | 18.0 | 18.0 | 18.0 | 18.0 | 18.0 |
| Deionized water 2 | in g | 6 | 9.0 | 18.0 | 20.0 | 17 |
| Mass of paint | in g | 382.0 | 415.0 | 446.6 | 462.8 | 451.0 |
| Appearance of | | defect | defect | defect | defect | defect |
| cured paint film | | free | free | free | free | free |
| Dry film | in μm | 37 | 35 | 34 | 33 | 34 |
| thickness | | | | | | |
| Pendulum | | 115 | 103 | 132 | 45 | 53 |
| hardness | | | | | | |
| gloss (measured | | 91 | 90 | 90 | 85 | 86 |
| at an angle of | | | | | | |
| 60°) | | | | | | |

Pendulum hardness: Pendulum hardness according to König (DIN 53157) measured after baking (20 minutes at 140° C.) and 1 hour of storage under standard conditions
*Wetting agent is ® Surfynol 104E (Air Products)
+ Filler is barium sulfate (® Blanc fixe super F, Sachtleben)
‡® Maprenal MF 904, Solutia Germany GmbH & Co. KG

Result:

All paints produced defect-free film surfacers; the gloss of paints 1, 2, and 3 (based on the inventive binders) is significantly higher than that of the comparative paints (paints 4 and 5). The film hardness of the coatings based on inventive binders (paints 1, 2, and 3) corresponds to the requirements imposed on aqueous automotive surfacers, whereas the film hardness of the comparative paints is clearly too low.

Metal Test Panels for the Stonechip Test:

Test system: Bonder 26 60° C. as substrate, 25 μm of a standard electrocoat primer, 35 μm of the aqueous surfacer of paints 1 to 5, 40 μm of a standard commercial acrylic-melamine topcoat.

| | |
|---|---|
| Baking conditions for | 30 minutes at 175° C. |
| the electrocoat primer: | |
| Baking conditions for | 20 minutes at 140° C. |
| surfacers (paints 1 to 5): | |
| Baking conditions for | 30 minutes at 140° C. |
| topcoat: | |

After the test panels prepared in this way had been baked they were stored under standard conditions for 24 hours and then subjected to a stonechip test in accordance with

DIN standard 55996-1 (2 passes each with 0.5 kg of angular shot material, pressure: 2 bar)

| | |
|---|---|
| Test panel 1: | electrocoat primer, surfacer based on |
| | paint 1, topcoat |
| Test panel 2: | electrocoat primer, surfacer based on |
| | paint 2, topcoat |
| Test panel 3: | electrocoat primer, surfacer based on |
| | paint 3, topcoat |
| Test panel 4 | electrocoat primer, surfacer based on |
| (comparative): | paint 4, topcoat |
| Test panel 5 | electrocoat primer, surfacer based on |
| (comparative): | paint 5, topcoat |

Result:

The stonechip indices compiled in Table 4 show that with the binders according to the invention outstanding results were obtained, while the comparisons without the addition of the hydroxyurethanes as an admixture resin give inadequate results in the stonechip test.

TABLE 4
Results of the stonechip test

| | Stonechip index according to DIN |
|---|---|
| | standard 55996-1 |
| Test panel 1 | 0 to 1 |
| Test panel 2 | 1 to 2 |
| Test panel 3 | 1 to 2 |
| Test panel 4 | 4 to 5 |
| Test panel 5 | 4 |

What is claimed is:

1. An aqueous binder comprising condensation products AB of carboxyl-containing resins A and hydroxyl group-containing resins B, hydroxyurethanes C, and curing agents D which are active even at temperatures starting at 120° C. wherein the hydroxy-urethanes C include units derived from polyfunctional hydroxy compounds Ca having at least 4 carbon atoms, it being possible for some of the carbon atoms to be replaced by oxygen atoms or by ester groups, and at least two hydroxyl groups, and units derived from polyfunctional isocyanates Cb selected from isocyanates of the formula R(NCO), where R is an n-functional cycloaliphatic, aliphatic-polycyclic, aromatic-aliphatic-branched or aromatic radical and n is at least 2.

2. The aqueous binder as claimed in claim 1, wherein the hydroxyurethanes C contain terminal hydroxyl groups.

3. The aqueous binder as claimed in claim 1, wherein the hydroxyurethanes C include units derived from diols Ca and diisocyanates Cb.

4. The aqueous binder as claimed in claim 1, wherein the curing agents D comprise water-dilutable amino resins D1 and blocked or nonblocked isocyanates D2.

5. The aqueous binder as claimed in claim 1, wherein the hydroxyurethanes C have a Staudinger index of from 4 to 19 cm³/g, measured in dimethylformamide solvent at 23° C.

6. The aqueous binder as claimed in claim 1, wherein the condensation products AB have an acid number of from 25 to 75 mg/g, and a Staudinger index of from 10 to 20 cm³/g, measured in dimethylformamide solvent at 23° C., and are obtainable by condensing hydroxyl-containing resins B having an hydroxyl number of from 50 to 500 mg/g and carboxyl-containing resins A having an acid number of from 100 to 230 mg/g.

7. The aqueous binder as claimed in claim 1, wherein the mass fraction of the hydroxyurethanes C in the sum of the masses of condensation products AB and admixture resin C is between 5 and 40%.

8. The aqueous binder as claimed in claim 1, wherein the mass fraction of the curing agents D in the sum of the masses of condensation products AB, the hydroxyurethanes C, and the curing agents D is from 2 to 20%.

9. A method of use of an aqueous binder as claimed in claim 1 to prepare an automotive surfacer material, wherein the condensation products AB first are mixed with the hydroxyurethanes C and neutralized, the mixture is then dispersed in water, a portion of this dispersion being intimately mixed with pigments and fillers and also, where appropriate, further additives, and then the remainder of the dispersion and the curing agent D and also, where appropriate, further water is added.

10. An automotive surfacer material comprising the aqueous binder as claimed in claim 1.
